(19) United States
(12) Patent Application Publication
(10) Pub. No.: US 2021/0107109 A1
(43) Pub. Date: Apr. 15, 2021

(54) METHOD FOR MACHINING DRILL WITH TILTING BLADE SLOT STRUCTURES FOR COMPOSITE MACHINING

(71) Applicant: DALIAN UNIVERSITY OF TECHNOLOGY, Dalian (CN)

(72) Inventors: Fuji WANG, Dalian (CN); Jianbo YAN, Dalian (CN); Meng ZHAO, Dalian (CN); Boyu ZHANG, Dalian (CN); Rao FU, Dalian (CN); Wei LIU, Dalian (CN); Jianwei MA, Dalian (CN); Zhenyuan JIA, Dalian (CN)

(21) Appl. No.: 17/023,012

(22) Filed: Sep. 16, 2020

(30) Foreign Application Priority Data
Oct. 15, 2019 (CN) 2019109754204

(51) Int. Cl. B24B 3/32

(52) U.S. Cl. CPC B24B 3/32

(57) ABSTRACT

A method for machining a drill with tilting blade slot structures for composite machining is provided. In the machining method, a face of the drill produces a downward component force for the inlet material to inhibit the inlet material from turning up; and a cutting edge inclination of an end surface at an outer turning point in a corner region of the drill is a positive value. The face and a flank are firstly partially ground in the corner region of the drill. The face at the outer turning point is ground with a grinding wheel to obtain two tilting blade slot structures. After grinding, a new face and a new cutting edge are obtained; and the cutting edge inclination on the end surface formed by the new cutting edge and a reference plane is a positive angle.

### TECHNICAL FIELD

The present invention belongs to the technical field of drilling tools in machining, and relates to a method for machining a drill with tilting blade slot structures for composite machining.

### BACKGROUND

Fiber reinforced plastic (FRP) has been widely applied in the aerospace field due to the advantages of high specific strength and corrosion resistance. To realize connection assembly, it is inevitable to make holes for composite members, such as dowel holes and counterweight holes of composite tail rotor blades of a helicopter. However, because the surface fiber of the composite is weakly constrained, damage such as burr and tear occurs frequently when metal drills are used to make holes. Especially when inlet materials are drilled, the surface fiber is easily bent upward under the action of a major cutting edge, causing delamination at the inlet, leading to cracks at the edges of the holes and forming the damage such as tear and burr at the inlet. Therefore, it is urgent to develop a tool which reduces the damage such as burr and tear at the drilling inlet of the composite.

At present, researchers have developed various drills to improve the hole making quality of the composite. Sun Sirui et al. of Shanghai Nagoya Precision Tool Co., Ltd. have invented a “drill for hole machining of fiber composite”, with patent application number ZL201310326585. The invention relates to a hole making drill for fiber composite with a drill tip having a first sharp point and a second sharp point. The hole making drill uses a sharp tip structure to cut fibers to inhibit the damage. However, the axial force generated by the drill when drilling the composite is too large, and is easy to produce delamination damage at an outlet. Ming Weiwei, et al. of Changzhou Shandi Intelligent Technology Co., Ltd. have invented a “drill for hole machining of fiber reinforced plastic” with patent application number ZL201711164856. The drill has variable helix angle and specific cut-in, cut-out angles and clearance angle, and can minimize the drilling torque. However, the tool cannot play a good cutting action on the inlet fiber of the composite, and causes serious inlet tear. It can be seen that the existing tool is difficult to make holes for the fiber composite at low inlet damage.

### SUMMARY

To solve the technical problem of making holes for the fiber composite at low inlet damage and avoiding the tear and burr at a drilling inlet, the present invention provides a method for machining a drill with tilting blade slot structures for composite machining. The present invention machines a drill with tilting blade slot structures. The tilting blade slot structures can make a cutting edge inclination of an outermost circle of the major cutting edge as a positive value, changes the current situation that the cutting edge inclination of the end surface of the traditional drill is negative, can effectively inhibit the delamination of the fiber material at the inlet, changes the flow direction of the chips, and reduces the tear damage at the inlet. Meanwhile, the tilting blade slot structures make the corner of the outer turning point of the major cutting edge sharper, so as to effectively cut the fiber and avoid the occurrence of the burr at the inlet. The tilting blade slot structures also reduce the rake angle of the tool at the outermost circle of the major cutting edge, so that chipping is difficult to occur, thereby finally making holes for the fiber composite at low inlet damage.

The technical solution of the present invention is:

A method for machining a drill with tilting blade slot structures for composite machining is provided. The machining method makes the cutting edge inclination of the end surface at the outer turning point as a positive value, ensures that the horizontal flow direction of the chips at the outer turning point during drilling points to a web along the radial direction of the drill, generates no radially outward component force on the fiber material at the edge of the hole and effectively reduces the tear damage at the edge of a hole inlet. A face produces a downward component force for the inlet material to inhibit the inlet material from turning up. Meanwhile, the outer turning point is sharper, which is beneficial for cutting the fiber, reducing the burr generated at the inlet and smoothly removing the chips.

The method includes: firstly, grinding a drill with the following features by using a hard alloy bar: grinding to ensure that the width W₁ of a chip space in a minor cutting edge region B is 0.8-0.9 time of the drilling diameter d₂ of a tool, wherein an angle formed by the chip space 3 and a tool axis 1, i.e., a helix angle n₁ of the chip space, is 30°-45°;

then, partially grinding a face and a flank of the drill to reduce the friction between the tool and the material and achieve a good heat dissipation effect;

grinding the face 9 near a chisel edge at a corner region C to obtain a ground face 10, wherein a rake angle n₅ is ground as 10°-20° herein; partially grinding the flank 5 to obtain a ground flank 6, wherein a clearance angle n₆ is 10°-20°;

finally, machining tilting blade slot structures D in the corner region C, i.e., grinding the face 9 herein with a grinding wheel at an outer turning point 11 of a major cutting edge 7 of the corner region C, to obtain two tilting blade slot structures D; grinding to obtain a new face 8 and a new cutting edge 12, wherein a cutting edge inclination n₇ on an end surface formed by the new cutting edge 12 and a reference plane 13 is a positive angle, i.e., 20°-35°; a tilting blade slot angle n₈ formed on the end surface by the tilting blade slot structures D is 80°-100°, and the length L₃ of the new cutting edge 12 is 0.9-1.2 mm; a rake angle n₄ at a machined tilting blade slot on the outer turning point 11 is a negative angle, i.e., 0° to −15°; the clearance angle n₃ at the tilting blade slot is unchanged, and the clearance angle n₃ at the tilting blade slot is the same as the clearance angle n₆, i.e., 10°-20°.

The present invention has the beneficial effects: the drill with tilting blade slot structures machined by the method can make the cutting edge inclination of the outermost circle of the major cutting edge as a positive value, changes the cutting state of the inlet fiber and the flow direction of the chips during hole making, changes the current status that the cutting edge inclination of the end surface of the traditional drill is negative, can effectively inhibit the delamination of the fiber material at the inlet, and reduces the tear damage at the inlet. Meanwhile, the rake angle and the clearance angle of the drill are partially ground so that the outer turning point is sharper. Under the joint action of the outer turning point and the negative rake angle, the damage such as tear and burr at the inlet can be effectively inhibited; machining at low damage is conducted; and the chips are removed smoothly. Finally, high-quality and high-efficiency hole making for the fiber composite is realized.

### DESCRIPTION OF DRAWINGS

FIG. 1 is a main view of a drill with tilting blade slot structures for composite machining.

FIG. 2 is an enlarged view of a corner region of FIG. 1.

FIG. 3 is an enlarged view of K direction of FIG. 1.

FIG. 4 is an inlet hole for machining a fiber reinforced plastic by the drill.

FIG. 5 is an outlet hole for machining a fiber reinforced plastic by the drill.

In the figures: A shank region; B minor cutting edge region; C corner region; D tilting blade slot structure;

1 tool axis; 2 land; 3 chip space; 4 minor cutting edge; 5 flank; 6 ground flank; 7 major cutting edge; 8 new face; 9 face; 10 ground face; 11 outer turning point; 12 new cutting edge; 13 reference plane;

W₁ width of chip space; W₂ land width;

n₁ chip space helix angle; n₂ angle between major cutting edge and tool axis; n₃ clearance angle at tilting blade slot; n₄ rake angle at tilting blade slot; n₅ ground rake angle; n₆ clearance angle; n₇ cutting edge inclination on end surface; n₈ tilting blade slot angle;

L₁ clamping length; L₂ cutting edge length; L₃ new cutting edge length; L₄ chisel edge length;

d₁ clamping diameter; d₂ drilling diameter.

### DETAILED DESCRIPTION

Detailed description of the present invention is described below in detail in combination with accompanying drawings and the technical solution.

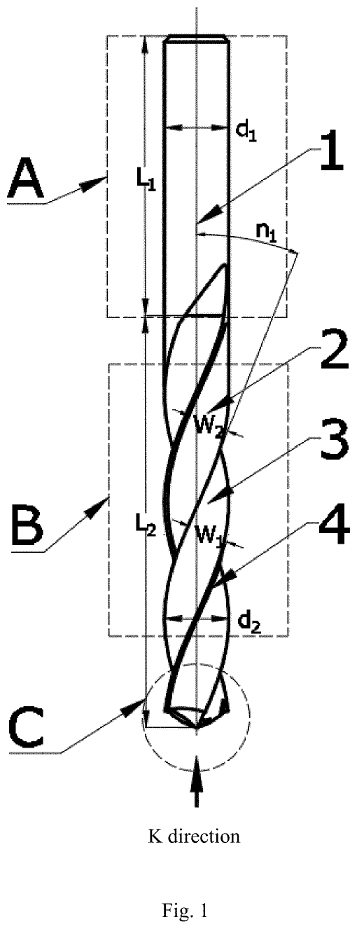

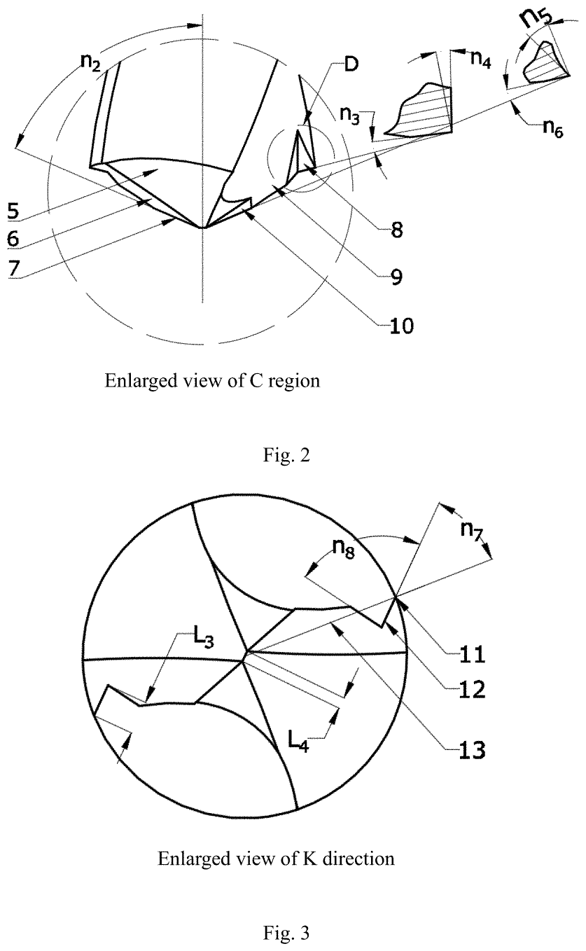

As shown in FIG. 1, FIG. 2 and FIG. 3, a drill with tilting blade slot structures in the present invention is composed of three parts: a shank region A of a tool clamping part, a minor cutting edge region B of a drill body part and a corner region C of a main cutting part of drilling. The minor cutting edge region B of the drill has two chip spaces 3 and two lands 2; the lands 2 have minor cutting edges 4; the width W₁ of the chip spaces is 0.8-0.9 time of the diameter d₂ of the tool; land width W₂ is 2.5-3.4 mm; and an angle n₁ formed by the chip spaces 3 and a tool axis 1 is 30°-45°. The tool diameter d₂ and cutting edge length L₂ can be set according to the diameter and depth of a drilling hole; and the length L₁ of the tool clamping part can also be set according to the diameter of the drill, which is generally 30-50 mm. The clamping diameter d₁ is generally Φ4 mm, Φ6 mm, Φ8 mm, etc.

In the present embodiment, firstly, a drill is ground to an original drill with the following features by using a hard alloy bar: grinding to ensure that the width W₁ of the chip spaces in the minor cutting edge region B is 0.8-0.9 time of the tool diameter d₂; d₂ is 8 mm; W₁ is 7.2 mm; and the angle n₁ formed by the chip spaces 3 and the tool axis 1 is 30°. The thickness of a web is one-third of the tool drilling diameter d₂. Proper thickness of the web and margin width can reduce the friction between the tool and the material, smoothly discharge the chips, and ensure that the tool rigidity meets the machining requirements. The length L₁ of the tool clamping part can also be set according to the diameter of the drill, and is 50 mm; the clamping diameter d₁ is a standard size of Φ8 mm; an angle n₂ formed by a major cutting edge 7 and the tool axis is 59°; and the land width W₂ is 2.5 mm.

Then, a face and a flank of the drill are partially ground to reduce the friction between the tool and the material and achieve a good heat dissipation effect. The face 9 near a chisel edge at the corner region C is ground to obtain a ground face 10, and a rake angle n₅ is ground as 10° herein; the flank 5 is partially ground to obtain a ground flank 6, and a clearance angle n₆ is 10°; chisel edge length L₄ ground at the drill tip is 0.4 mm; and a short chisel edge can reduce the axial drilling force and reduce the delamination damage at the outlet.

Finally, tilting blade slot structures (D) are ground in the corner region (C) at the outermost circle of the major cutting edge 7 of the tool; and the face 9 herein is ground with a grinding wheel to obtain two tilting blade slot structures D. Meanwhile, after grinding, a new face 8 and a new cutting edge 12 are obtained; a rake angle n₄ at the formed tilting blade slot is a negative angle, i.e., −15°; and the face produces a downward component force for the inlet material before drilling to inhibit the inlet material from turning up. Observing from the bottom, two edges of the tilting blade slot form a right angle n₈ of the tilting blade slot; the cutting edge inclination n₇ on the outer turning point of the drill is positive, i.e., 20°; and the length L₃ of the new cutting edge is 1.2 mm to ensure that the depth of the tilting blade slot is not greater than the ground flank.

The tilting blade slot structure has the main functions of changing the drilling cutting edge inclination n₇ at the outer turning point 11 to a positive value, making the corner and outer turning point 11 sharper, ensuring that the horizontal flow direction of the chips at the outer turning point is inward along the radial direction of the drill, generating no radial outward component for the fiber material on the edge of the hole, and effectively reducing the tear damage at the edge of the hole inlet.

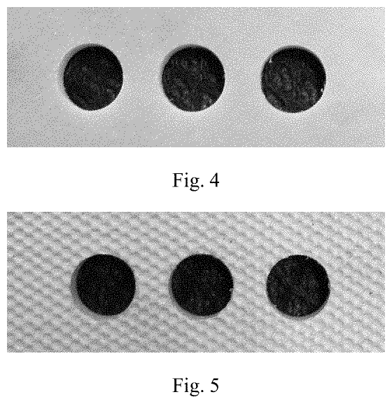

An experimental platform uses a five-axis high precision machining center, and the drill is made of carbide without coating. Dry cutting is adopted without cooling. The spindle speed is 6000 rpm, the feed speed is 400 mm/min, and drilling is performed for three times. A machining workpiece is a fiber reinforced plastic laminate from Boeing with a thickness of 5 mm. The machining workpiece is used for the manufacture of Boeing aircraft, is easy to produce inlet burr during machining, is very representative and challenging, and can also embody the practicality of the present invention. FIG. 4 and FIG. 5 respectively show the quality of the inlet hole and the outlet hole machined by the drill. When the inlet surface and the outlet surface are carefully observed, the inlets of three machined holes have no burr and tear damage, and the quality is very good. When the first hole is machined, the outlet has no delamination and burr damage, and the quality is very good. When the third hole is machined, the outlet is still very good and has no delamination and burr damage. It can be seen that on the premise of ensuring the quality of the hole outlet, the drill can effectively inhibit the inlet damage during hole making of the composite and has good machining quality; and the tool has long service life.

The drill with tilting blade slot structures machined by the present invention can make the cutting edge inclination on the end surface of the outermost circle of the major cutting edge as a positive value, changes the cutting state of the fiber of the drilling inlet, inhibits the weakly constrained inlet surface material from spontaneously turning up, and reduces the tear damage at the inlet. The tilting blade slot structures make the outer turning point of the tool sharper, which is beneficial for cutting the fiber and reducing the burr damage at the inlet. Finally, high-quality and high-efficiency hole making for the fiber composite is realized.

The method for machining the drill with tilting blade slot structures for composite machining in the present invention is not limited to the structures of the above embodiments, and can be varied in many forms. In conclusion, all improvements without departing from the innovation scope of the patent of the present invention fall within the protection scope of the patent of the present invention.

1. A method for machining a drill with tilting blade slot structures for composite machining, comprising the following steps:
firstly, grinding a drill with the following features by using a hard alloy bar: grinding to ensure that the width W₁ of a chip space in a minor cutting edge region B is 0.8-0.9 time of the drilling diameter d₂ of a tool, wherein an angle formed by the chip space (3) and a tool axis (1), i.e., a helix angle n₁ of the chip space, is 30°-45°;
then, partially grinding a face and a flank of the drill to reduce the friction between the tool and the material and achieve a good heat dissipation effect; grinding the face (9) near a chisel edge at a corner region (C) to obtain a ground face (10), wherein a rake angle n₅ is ground as 10°-20° herein; partially grinding the flank (5) to obtain a ground flank (6), wherein a clearance angle n₆ is 10°-20°;
finally, machining tilting blade slot structures (D) in the corner region (C), i.e., grinding the face (9) herein with a grinding wheel at an outer turning point (11) of a major cutting edge (7) of the corner region (C), to obtain two tilting blade slot structures (D); grinding to obtain a new face (8) and a new cutting edge (12), wherein a cutting edge inclination n₇ on an end surface formed by the new cutting edge (12) and a reference plane (13) is a positive angle, i.e., 20°-35°; a tilting blade slot angle n₈ formed on the end surface by the tilting blade slot structures (D) is 80°-100°, and the length L₃ of the new cutting edge (12) is 0.9-1.2 mm; a rake angle n₄ at a machined tilting blade slot on the outer turning point (11) is a negative angle, i.e., 0° to 15°; the clearance angle n₃ at the tilting blade slot is unchanged, and the clearance angle n₃ at the tilting blade slot is the same as the clearance angle n₆, i.e., 10°-20°.
